(19) United States
(12) Patent Application Publication
(10) Pub. No.: US 2012/0218970 A1
(43) Pub. Date: Aug. 30, 2012

(54) Caching in Mobile Networks

(76) Inventors: Lars Westberg, Enkoping (SE); Ayodele Damola, Solna (SE); Stefan Hellkvist, Stockholm (SE)

(21) Appl. No.: 13/395,554

(22) PCT Filed: Jan. 28, 2010
(86) PCT No.: PCT/EP2010/051031

§ 371 Date: May 14, 2012

Related U.S. Application Data
(60) Provisional application No. 61/244,248, filed on Sep. 21, 2009.

(51) Int. Cl. H04W 36/02

(52) U.S. Cl. 370/331

(57) ABSTRACT

There is described a system and method of handing over a connection to a terminal from a source network element (e.g. base station) to a target network element (e.g. base station) in a packet data network when the source base station is acting as a caching server and sending content data towards the terminal in a session. A handover request is sent from the source base station to the target base station. A context data message (e.g. CXTP message) is sent from the source base station to the target base station, the context data message including session state parameters identifying the state of the session. At the target base station, the session state parameters are retrieved from the context data message and used to identify the state of the session. Content data packets are then sent from the target base station towards the terminal so as to continue the session.

### TECHNICAL FIELD

The present invention relates to a system for caching data in mobile packet data networks. In particular, the invention relates to a caching architecture suitable for streaming data to users roaming between different base stations. The invention is applicable, but not limited to, a mechanism for caching content in a Video on Demand (VoD) system.

### BACKGROUND

Typical file caching methods include a cache receiving a file from a file server, and storing the entire file. Later when a client desires the file, instead of serving the file from the file server, the file is served from the cache. Because the cache is typically a server that is closer to the client, or has higher bandwidth than the file server, the file is served to the client quickly from the cache.

The application of typical file caching methods to files that include streaming media data, for example Video on Demand (VoD) files, can lead to new problems. VoD systems generally either stream content through a set-top box, allowing viewing in real time, or download it to a device such as a computer, digital video recorder, personal video recorder or portable media player for viewing at any time. The data delivered by networks delivering such content can run to very large amounts, and caching can be particularly useful.

This can be understood with reference to FIG. 1, which is a schematic illustration of an exemplary architecture of a VoD system with deployed caches used to reduce the load on a central long-tail server. In the example, it can be supposed that the network uses Real-Time Streaming Protocol (RTSP) streaming, where the payload is transported over the User Datagram Protocol (UDP) in Real-Time Protocol (RTP) packets, but it will be appreciated that many other applications and protocols have a similar architecture and will have similar issues.

The architecture of FIG. 1 includes a network 100 having an origin server 101 and a number of caches 102-106. Clients 107-109 are configured to receive files and/or streaming data from the origin server 101 or the caches 102-106. The clients use RTSP to set up and control streams of RTP packets. This includes the negotiation of codecs, bitrates, ports etc for the resulting RTP stream. With RTSP the clients can start and stop the streaming, or fast forward or rewind the streamed media clip.

RTP packets are sent in sequence with a sequence number to tell the client the order of the packets. This infers a state into the protocol that the streaming server 101 needs to maintain and increment for each data packet it sends out. The sequence number is also used by the clients 107-109 to detect packet loss which is reported back to the streaming server using the Real-Time Transport Control Protocol (RTCP).

In order to reduce the load on the origin server 101 and to save bandwidth in the delivery network 100, some of the content is stored in caches 102-106 closer to the end users 107-109. It is desirable to push these caches as close to the end user as possible. However, this can give rise to problems in certain situations, especially if there is mobility in the network so that the client can move around during a session (such as a mobile terminal moving between base stations). Using the example above, suppose one of the clients 107 is receiving data from one of the caches 104. If the client 107 moves location so that it is now receiving data from another cache 105, dynamic parameters such as the session state (in this example, the RTP packet sequence number) need to be migrated into the new cache 105, which may or may not also include the relevant content, so that the session can continue in the new place without interruption.

Although caching solutions have been shown as an effective way of reducing the load on the transport network and have been proposed for video streaming, these solutions mainly focus on public Internet architectures and do not address the issues of mobility which is a vital part of 3GPP networks.

System Architecture Evolution/Long Term Evolution (SAE/LTE) networks provide mobility below a Point-of Present (PoP). In such networks, caching can in principle be located anywhere, but traffic is tunnelled between the nodes (due to mobility). If caching is added into the reference architecture, it is preferable that the break-out of traffic from the tunnels is made at serving gateways or base stations, or that the caches are located above the PoP—i.e. within the operator's IP-service network. This means that an application state in a cache must be moved at handover between caches, implying very complex state transfers.

Long Term Evolution (LTE) is a communication network technology currently under development by the 3rd Generation Partnership Project (3GPP). LTE requires a new radio access technique termed Evolved Universal Terrestrial Radio Access Network (E-UTRAN), which is designed to improve network capacity, reduce latency in the network, and consequently improve the end-user's experience. System Architecture Evolution (SAE) is the core network architecture for LTE communication networks.

Referring to FIG. 2, the LTE/SAE architecture includes a Mobility Management Entity (MME) 24, which is responsible for control signalling. An SAE Gateway (SAE-GW) is responsible for the user data. The SAE-GW consists of two different parts, namely a Serving Gateway 25 that routes user data packets, and a PDN Gateway 26 that provides connectivity between a user device and an external data network, such as a network 27 in which an operator is located to provide services such as IPTV 28 and IMS 29. These nodes are described in detail in 3GPP Technical Specification (TS) 23.401. All these nodes are interconnected by an IP network. Further nodes are the eNodeBs 22, 23, which act as base stations in the network. A Policy and Charging Rules Function, PCRF 30, detects the service flow and enforces charging policy. There are three major protocols and interfaces between these node types. These are S1-MME (between the eNodeBs 23, 23 and the MME 24), S1-U (between the eNodeBs 22, 23 and the SAE-GW 25, or more correctly between the eNodeBs 22, 23 and the Serving Gateway), and X2 (between eNodeBs 22, 23). The corresponding protocols used in these interfaces are S1AP (S1 Application Protocol) and X2AP (X2 Application Protocol). All these protocols and interfaces are IP-based. In addition, the network may contain other nodes that are part of the above interface, for example a Home eNodeB Gateway (not shown in FIG. 2) between a Home eNodeB and rest of the nodes in the network. Currently, mobility is provided below the PDN SAE GW 26.

Before considering how mobility affects caches, it is helpful to consider the handover procedure in SAE/LTE networks when a mobile terminal 21 moves from a source eNodeB (eNB) 22 to a target eNB 23. According to 3GPP TS 36.300, the handover procedure is performed without involvement of the Evolved Packet Core (EPC), i.e. preparation messages are directly exchanged between the eNBs 22, 23. The release of the resources at the source side during the handover completion phase is triggered by the source eNB 22. FIG. 3 depicts the basic handover scenario for a terminal 21 moving from a source eNB 22 to a target eNB 23 where neither the MME 24 nor Serving Gateway 25 changes. The steps shown in FIG. 3 are as follows:

S0. The UE context within the source eNB 22 contains information regarding roaming restrictions which where provided either at connection establishment or at the last TA update.
S1 The source eNB 22 configures the terminal 21 measurement procedures according to the area restriction information. Measurements provided by the source eNB 22 may assist the function controlling the terminal's connection mobility.
S2 The terminal 21 is triggered to send MEASUREMENT REPORT by the rules set by e.g. system information, specification etc.
S3 Source eNB 22 makes decision based on MEASUREMENT REPORT and RRM information to hand off terminal 21.
S4 The source eNB 22 issues a HANDOVER REQUEST message to the target eNB 23 passing necessary information to prepare the handover at the target side (UE X2 signalling context reference at source eNB, UE S1 EPC signalling context reference, target cell ID, K_{eNB*}, RRC context including the C-RNTI of the terminal in the source eNB, AS-configuration (excluding physical layer configuration), E-RAB context and physical layer ID of the source cell+MAC for possible RLF recovery). UE X2/UE S1 signalling references enable the target eNB 23 to address the source eNB 22 and the EPC. The E-RAB context includes necessary RNL and TNL addressing information, and QoS profiles of the E-RABs.
S5 Admission Control may be performed by the target eNB 23 dependent on the received E-RAB QoS information to increase the likelihood of a successful handover, if the resources can be granted by target eNB 22. The target eNB 23 configures the required resources according to the received E-RAB QoS information and reserves a C-RNTI and optionally a RACH preamble. The AS-configuration to be used in the target cell can either be specified independently (i.e. an “establishment”) or as a delta compared to the AS-configuration used in the source cell (i.e. a “reconfiguration”).
S6 Target eNB 23 prepares handover with L1/L2 and sends the HANDOVER REQUEST ACKNOWLEDGE to the source eNB 22. The HANDOVER REQUEST ACKNOWLEDGE message includes a transparent container to be sent to the terminal 21 as an RRC message to perform the handover. The container includes a new C-RNTI, target eNB security algorithm identifiers for the selected security algorithms, may include a dedicated RACH preamble, and possibly some other parameters i.e. access parameters, SIBs, etc. The HANDOVER REQUEST ACKNOWLEDGE message may also include RNL/TNL information for the forwarding tunnels, if necessary.

As soon as the source eNB 22 receives the HANDOVER REQUEST ACKNOWLEDGE, or as soon as the transmission of the handover command is initiated in the downlink, data forwarding may be initiated.

Steps S7 to S16 provide means to avoid data loss during handover, and are discussed in more detail in 3GPP TS 36.300.

S7 The source eNB 22 generates the RRC message to perform the handover, i.e RRCConnectionReconfiguration message including the mobifityControlInformation towards the terminal 21. The source eNodeB 22 performs the necessary integrity protection and ciphering of the message. The terminal 21 receives the RRCConnectionReconfiguration message with necessary parameters (i.e. new C-RNTI, target eNB security algorithm identifiers, and optionally dedicated RACH preamble, target eNB SIBs etc) and is commanded by the source eNB 22 to perform the handover. The terminal does not need to delay the handover execution for delivering the HARQ/ARQ responses to the source eNB 22.
S8 The source eNB 22 sends the SN STATUS TRANSFER message to the target eNB 23 to convey the uplink PDCP SN receiver status and the downlink PDCP SN transmitter status of E-RABs for which PDCP status preservation applies (i.e. for RLC AM). The uplink PDCP SN receiver status includes at least the PDCP SN of the first missing UL SDU and may include a bit map of the receive status of the out of sequence UL SDUs that the terminal needs to retransmit in the target cell, if there are any such SDUs. The downlink PDCP SN transmitter status indicates the next PDCP SN that the target eNB shall assign to new SDUs, not having a PDCP SN yet. The source eNB 22 may omit sending this message if none of the E-RABs of the terminal 21 shall be treated with PDCP status preservation.
S9 After receiving the RRCConnectionReconfiguration message including the mobifityControlInformation, the terminal 21 performs synchronisation to the target eNB 23 and accesses the target cell via RACH following a contention-free procedure if a dedicated RACH preamble was allocated in HANDOVER COMMAND or following a contention-based procedure if no dedicated preamble was allocated. The terminal 21 derives target eNB specific keys and configures the selected security algorithms to be used in the target cell.
S10 Network responds with UL allocation and timing advance.
S11 When the terminal 21 has successfully accessed the target cell, the terminal 21 sends the RRCConnectionReconfigurationComplete message (C-RNTI) to confirm the handover along with an uplink Buffer Status Report whenever possible to the target eNB to indicate that the handover procedure is completed for the terminal. The target eNB 23 verifies the C-RNTI sent in the HANDOVER CONFIRM message. The target eNB 23 can now begin sending data to the terminal 21.
S12 The target eNB 23 sends a PATH SWITCH message to the MME 24 to inform that the terminal 21 has changed cell.
S13 The MME 24 sends a USER PLANE UPDATE REQUEST message to the Serving Gateway 25.
S14 The Serving Gateway 25 switches the downlink data path to the target side. The Serving gateway sends one or more “end marker” packets on the old path to the source eNB 22 and then can release any U-plane/TNL resources towards the source eNB.
S15 Serving Gateway 25 sends a USER PLANE UPDATE RESPONSE message to MME 24.
S16 The MME 24 confirms the PATH SWITCH message with the PATH SWITCH ACK message.
S17 By sending UE CONTEXT RELEASE the target eNB 23 informs success of handover to the source eNB 22 and triggers the release of resources. The target eNB 23 sends this message after the PATH SWITCH ACK message is received from the MME 24.
S18 Upon reception of the UE CONTEXT RELEASE message, the source eNB 22 can release radio and C-plane related resources associated to the UE context.

In the case of a SAE/LTE network architecture, mobility of a user causes a change in attachment points into the network and introduces the following issues:
Session transfer due to mobility. If a cache is used below the mobility anchor points (i.e. the user moves from cache to cache), the complexity of having application states within the cache generates complexity during handoffs.
Interactions with Policy control. One of the main problems is that application nodes such as streaming servers need to interact with the Policy Charging Rule Function (PCRF) to control the usage of QoS. However, the PCRF is located above the anchor-point in the EPC-architecture and this causes a problem for a cache below the anchor-point.
Scalability. A problem is that a centralized generation of payload requires high-capacity nodes and is difficult to scale when more traffic needs to be generated.

This it can be seen that handover in mobile networks generates a complex transfer of the application states between a distributed set of caches. A robust caching solution requires a well designed and a flexible solution for session state transfer between base-stations in an SAE/LTE architecture.

### SUMMARY

It is the object of the present invention to obviate at least some of the above disadvantages.

It would be desirable to maintain the streaming session state for UDP based streaming protocols during handover when an origin server delegates the serving of the stream to terminals to a cache located at the edge of the network.

In accordance with one aspect of the present invention there is provided a “source” network element configured to act as a caching server for sending cached data in a session to a mobile terminal in a packet data network. The source network element comprises a control unit for controlling the delivery of cached data packets, stored in a cache storage unit associated with the source network element, to the terminal. A local storage medium is associated with the control unit and is configured to store session state parameters defining a state of the session. The network element also includes a communications system configured to send the cached data packets towards the terminal. The control unit is configured to implement a handover procedure to a target network element in the network so as to enable the target network element to send the cached data packets towards the terminal in the same session. The handover procedure includes retrieving the session state parameters from the local storage medium, inserting the session state parameters into a context data message, and using the communications system to send the context data message to the target network element.

Thus by sending a context message towards the target network element, it is possible to operate a flat caching architecture, allowing a gracious state transfer between network elements operating as caching servers.

The communications system may be further configured to initiate the handover procedure by sending a handover request to the target network element following an identification that the terminal has moved within range of the target network element.

The context data message may be a CXTP data message.

The control unit may be configured to operate a data delivery process, cache state-transfer process, and CXTP process. The cache state-transfer process may be configured to recover the session state parameters from the data delivery process and deliver them to the CXTP process, and the CXTP process may be configured to insert the parameters into the context data message and send them to the target network element.

In accordance with another aspect of the present invention there is provided a “target” network element configured to act as a caching server for sending cached data to a mobile terminal in a packet data network. The target network element comprises a control unit for controlling the delivery of cached data packets, stored in a cache storage unit associated with the network element, to the terminal. A local storage medium is associated with the control unit and is for storing session state parameters defining a state of the session. The target network element also comprises a communications system configured to send the cached data packets towards the terminal. The control unit is configured to implement a handover procedure from a source network element in the network so as to enable the target network element to continue to send the cached data packets towards the terminal in a session previously handled by the source network element. The handover procedure includes receiving a context data message from the source network element at the communications system, the context data message containing session state parameters defining the state of the session, inserting the session state parameters into the local storage medium, identifying the state of the session from the session state parameters, and using the identified state to identify a starting point in the cached data packets to be sent towards the terminal.

The communications system may be further configured to receive a handover request from the source network element to initiate the handover procedure.

The context data message may be a CXTP data message.

The control unit may be configured to operate a data delivery process, cache state-transfer process, and CXTP process The cache state-transfer process may be configured to recover the session state parameters from the CXTP process and deliver them to the data delivery process, and the data delivery process may be configured to deliver the parameters to the local storage medium and to control delivery of cached data packets to the terminal.

It will be appreciated that network elements may be configured to act both as “target” and “source” network elements as defined above. In either case, the cache storage unit may be included in the network element. The network element may be a base station.

The cached data sent to the mobile terminal may be streaming data, for example HTTP streaming data.

The packets may be RTP packets.

The packet data network may be a 3GPP or SAE LTE network, and the network element may be an eNodeB.

In accordance with another aspect of the present invention there is provided a method of handing over a connection to a terminal from a source base station to a target base station in a packet data network when the source base station is acting as a caching server and sending content data towards the terminal in a session. A handover request is sent from the source base station to the target base station. A context data message is sent from the source base station to the target base station, the context data message including session state parameters identifying the state of the session. At the target base station, the session state parameters are retrieved from the context data message and used them to identify the state of the session. The content data packets are then sent from the target base station towards the terminal so as to continue the session.

In accordance with another aspect of the present invention there is provided a computer program product comprising code adapted to be executed on a source network element in a packet data network. The code is operable to: retrieve content data packets from a cache storage medium associated with the network element; send the content data packets in a session towards a terminal in the network; send a handover request to a target network element in the network; insert current session state parameters into a context data message and send the context data message towards the target network element; and stop sending the content data packets towards the terminal.

In accordance with a further aspect of the present invention there is provided a computer program product comprising code adapted to be executed on a target network element in a packet data network, The code is operable to: receive a handover request from a source network element in the network; receive a context data message from the source network element, the context data message including session state parameters for a data delivery session to a terminal in the network; store the session state parameters in a local storage medium; use the session state parameters to identify a state of the data delivery session; retrieve content data packets intended for the data delivery session from a cache storage medium associated with the network element, the content data packets being chosen so that the data delivery session to the terminal can continue uninterrupted; and send the content data packets towards the terminal so as to continue the data delivery session.

The invention also includes a carrier medium carrying any of the programs described above.

### BRIEF DESCRIPTION OF THE DRAWINGS

Some preferred embodiments will now be described by way of example only and with reference to the accompanying drawings, in which:

FIG. 1 is a schematic illustration of a network architecture;

FIG. 2 is a schematic illustration of a LTE/SAE network;

FIG. 3 is a sequence diagram illustrating the handover procedure in LTE/SAE networks;

FIGS. 4A and 4B are sequence diagrams illustrating the exchange of CXTP messages;

FIG. 5 is an illustration of the content of a Context Transfer Request (CT-Req) message;

FIG. 6 is an illustration of the content of a Context Transfer Data (CTD) message;

FIG. 7 is an illustration of the content of a Context data block (CDB);

FIG. 8 is an illustration of a SCTP payload data chunk in a CDB as envisaged in the CXTP;

FIG. 9 is a schematic illustration of the operation of HTTP streaming;

FIG. 10 is a schematic illustration of the LTE/SAE network of FIG. 2 showing possible locations for caches;

FIG. 11 is a sequence diagram illustrating a handover procedure including cache context transfer;

FIG. 12 is a schematic illustration of a source eNodeB and target eNodeB configured to transfer cache context during handover; and

FIG. 13 is a sequence diagram illustrating the operations carried out in transferring cache status.

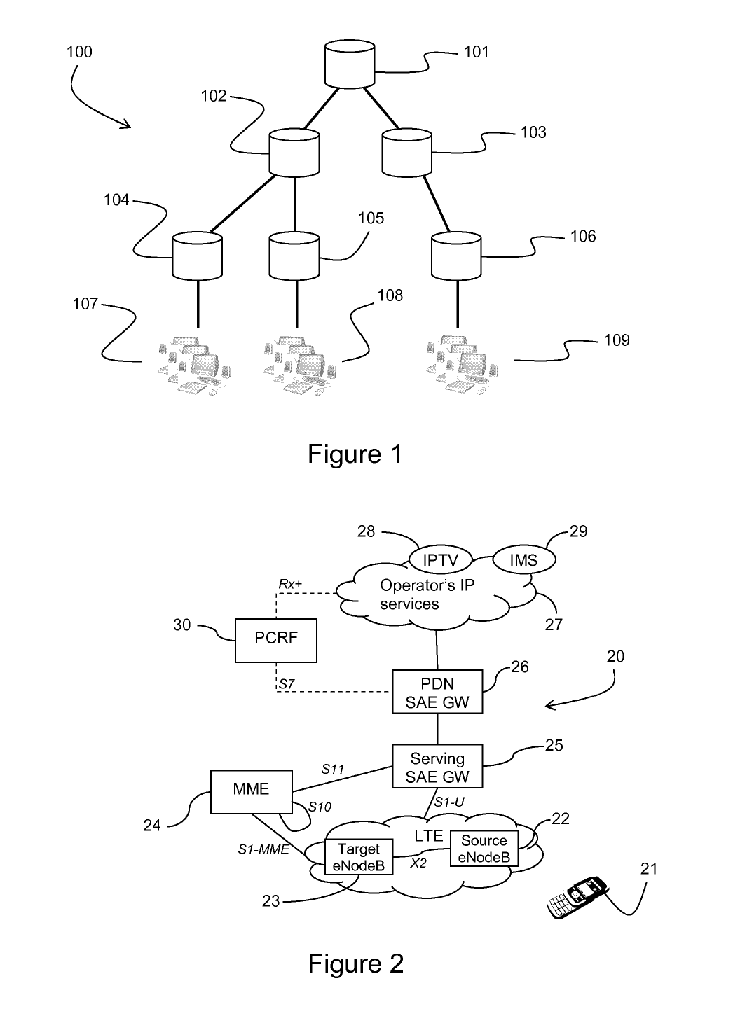

### DETAILED DESCRIPTION

In order to understand the principles involved in maintaining session parameters, an exemplary embodiment is described with reference to an LTE network. It will be appreciated that this embodiment is provided by way of example only, and that the same approach may be used for other network architectures and communication protocols. Furthermore, the use of RTSP is described, but any other UDP based streaming protocol (e.g. MPEG transport stream (MPEG TS)) can also be used, or any other protocol which controls the transmission of data in a session (e.g. large files).

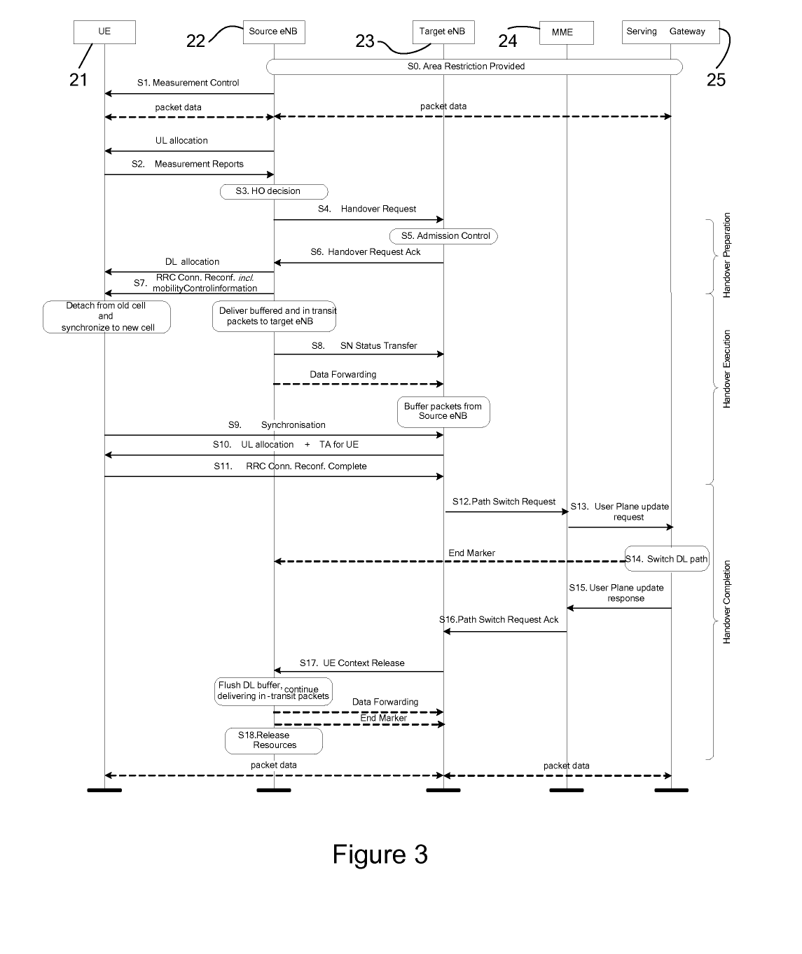

A flat mobility architecture has been suggested in IETF, where the edges of the network are denoted as “Access Routers.” These routers are assumed to have an embedded air-interface and can, from an SAE/LTE perspective, be modelled as an integrated SAE/LTE node. However, the main focus of RFC 4067 is to define a state-transfer protocol between the edge-router, and can be used as a container for mobility initiated transfer of states between nodes. The terminology of RFC refers to transfer between a “previous access router” (pAR) and a “next access router” (nAR). These correspond to the source eNB 22 and target eNB 23 shown in FIGS. 2 and 3.

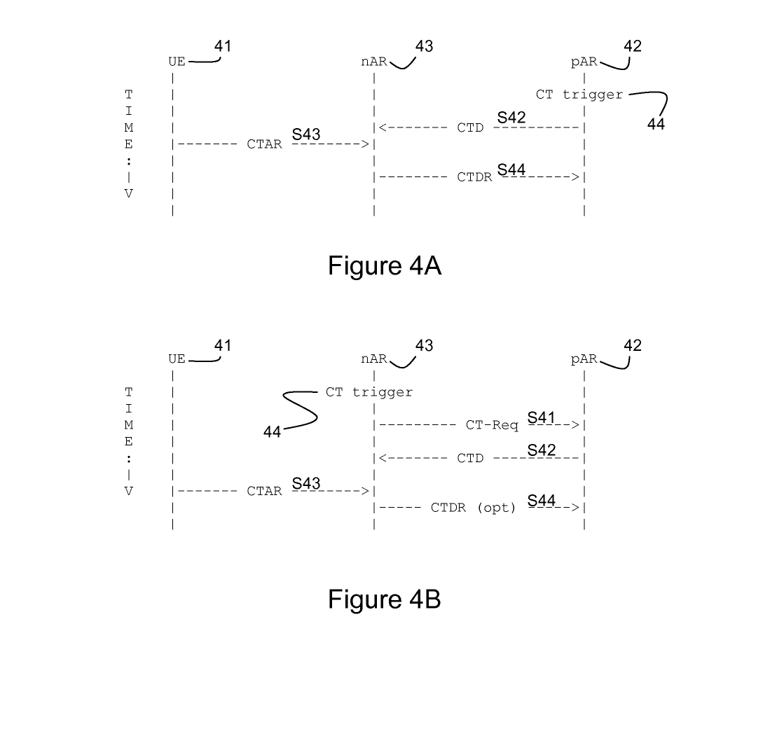

FIGS. 4A and 4B are sequence diagram examples of the interactions between a UE 41, pAR 42 and nAR 43 in response to a context (CT) trigger 54. In FIG. 4A the CT trigger is received by the pAR 42, and in FIG. 4B the trigger is received by the nAR 43. The UE 41, nAR 42 and nAR 43 could be the UE 21, source eNB 22 and target eNB 23 shown in FIGS. 2 and 3, and the CT trigger 44 could be the handover initiation message or decision described in S3, S4 with reference to FIG. 2. The steps are as follows:

S41 If the CT trigger 44 is initiated at the nAR 43, a Context Transfer Request (CT-Req) message is sent by nAR to pAR to request the start of context transfer. This message is sent as a response to a Context Activate (CTAR) message. The fields following the Previous IP address of the MN are included verbatim from the CTAR message.
S42 A Context Transfer Data Message (CTD) is sent from the pAR 42 to the nAR 43, and includes feature data (CXTP data). This message handles both predictive and normal Context. An acknowledgement flag, ‘A’, included in this message indicates whether a reply is required by the pAR 42.
S43 A CTAR message is sent from the UE 41 to the nAR 43. The CTAR message provides the IP address of the nAR 43, the IP address of the UE 41 MN on the pAR 42, the list of feature contexts to be transferred (by default requesting all contexts to be transferred), and a token authorizing the transfer.
S44 A CTD Reply (CTDR) message is sent from the nAR 43 to the pAR 42.

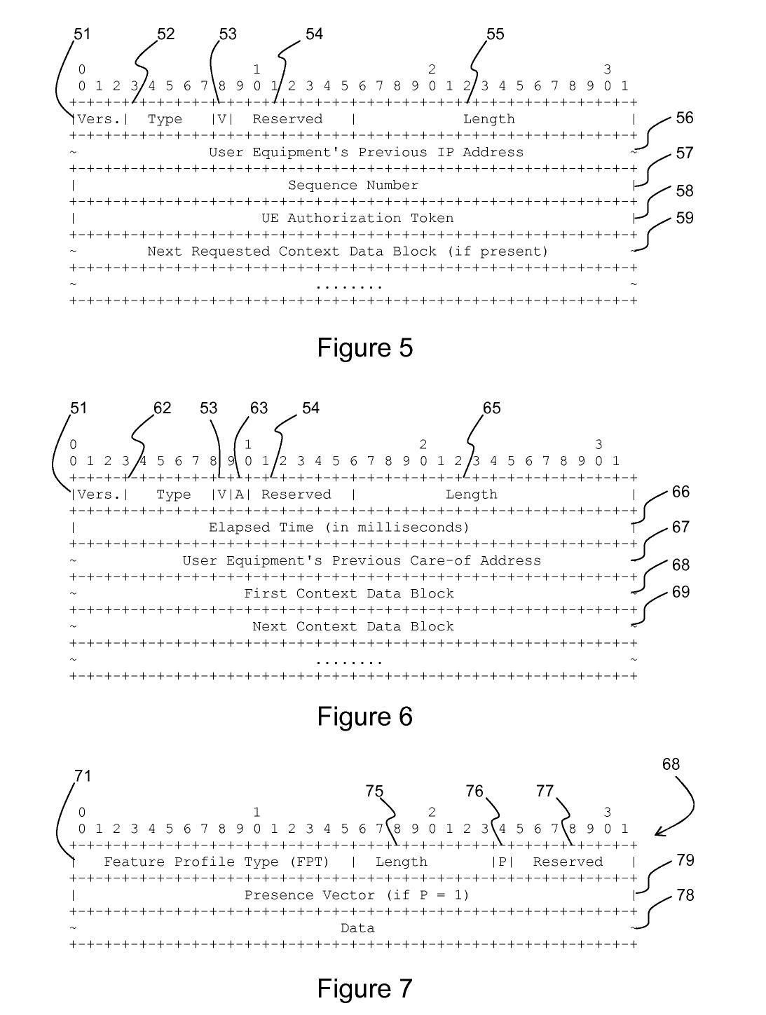

The CT-Req message (see step S41) is shown in FIG. 5, and includes fields as follows:
Vers. 51 Version number of CXTP protocol=0x1
Type 52 CTREQ=0x7 (Context Transfer Request)
‘V’ flag 53 When set to ‘0’, IPv6 addresses.
   When set to ‘1’, IPv4 addresses.
Reserved 54 Set to zero by the sender and ignored by the receiver.
Length 55 Message length in units of octets.
UE's Previous IP Address Field 56 contains either:
   IPv4 [RFC791] Address, 4 octets, or
   IPv6 [RFC3513] Address, 16 octets.
Sequence Number 57
   Copied from the CTAR message, allows the pAR to distinguish requests from previously sent context.
UE's Authorization Token 58
   An unforgeable value. This authorizes the receiver of CTAR to perform context transfer. Copied from CTAR.
Context Data Request Block 59
   A request block for context data.

The CTD Message (see step S42) is shown in FIG. 6 and includes fields as follows:
Vers. 51 Version number of CXTP protocol=0x1
Type 62 CTD=0x3 (Context Transfer Data)
   PCTD=0x4 (Predictive Context Transfer Data)
‘V’ flag 53 When set to ‘0’, IPv6 addresses.
   When set to ‘1’, IPv4 addresses.
‘A’ bit 63 When set, the pAR requests an acknowledgement.
Length 65 Message length in units of octets.
Elapsed Time 66
   The number of milliseconds since the transmission of the first CTD message for this MN.
UE's Previous IP Address Field 67 contains either:
   IPv4 [RFC791] Address, 4 octets, or
   IPv6 [RFC3513] Address, 16 octets.
Context data blocks 68, 69
   Described below

The context data block (CDB) 68, 69 is shown in FIG. 7 and includes the following fields:
Feature Profile Type 71
   16 bit integer, assigned by IANA, indicating the type of data included in the Data field.
Length 75 Message length in units of 8 octet words.
‘P’ bit 76 0=No presence vector.
   1=Presence vector present.
Reserved 77 Reserved for future use. Set to zero by the sender.

Data 78 Context type-dependent data, whose length is defined by the Length Field. If the data is not 64 bit aligned, the data field is padded with zeros.

The Feature Profile Type (FPT) code 71 indicates the type of data in the data field 78. Typically, this will be context data, but it could be an error indication. The ‘P’ bit 76 specifies whether a “presence vector” 79 is used. When the presence vector 79 is in use, it is interpreted to indicate whether particular data fields are present (and contain non-default values). The ordering of the bits in the presence vector 79 is the same as the ordering of the data fields according to the context type specification, one bit per data field regardless of the size of the data field. The Length field 75 indicates the size of the CDB 68 in 8 octet words, including the first 4 octets starting from FPT 71.

It will be noted that the length of the context data block 68 is defined by the sum of the lengths of each data field 78 specified by the context type specification, plus 4 octets if the ‘P’ bit is set, minus the accumulated size of all the context data that is implicitly given as a default value.

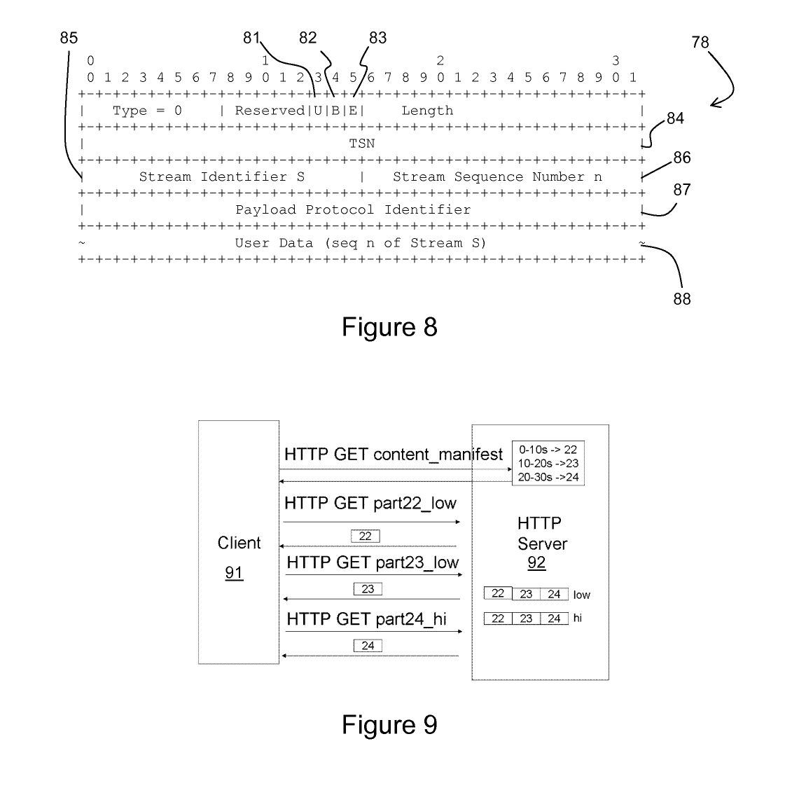

It has also been decided that deployments of CXTP should use the Stream Control Transport Protocol (SCTP) as the transport protocol on the inter-router interface. SCTP supports congestion control, fragmentation, and partial retransmission based on a programmable retransmission timer. The payload data 78 shown in FIG. 7 then has a format as shown in FIG. 8, where the fields are as follows:
‘U’ bit 81 The Unordered bit. Must be set to 1.
‘B’ bit 82 The Beginning fragment bit.
‘E’ bit 83 The Ending fragment bit.
TSN 84 Transmission Sequence Number.
Stream Identifier S 85
   Identifies the context transfer protocol stream.
Stream Sequence Number n 86
   Since the ‘U’ bit is set to one, the receiver ignores this number.
Payload Protocol Identifier 87
   Set to ‘CXTP’.
User Data 88 Contains the context transfer protocol messages.

Ongoing industry trends point to the fact that HTTP will be used to retrieve video streams. This is a variant of progressive download. The main feature is that the original video file is broken into segments or chunks, which are basically small individual files, and these are downloaded by the client instead of one big file.

The main reason for the development of this type of mechanism is due to the fact that the RTSP/RTP protocol has problems with firewalls and NATs and hence streaming with this protocol over the Internet is not always possible. HTTP uses port 80 and there are no issues with firewall and NAT transverse as this port is open because it is used by all Web traffic. Caching of such content becomes possible and an important point is that the caching infrastructure (known as CDN) does not have to be changed, since it was from the start intended for caching Web content (files fetched over HTTP). This means that existing CDN infrastructure can be easily re-used.

The trend can be seen in the activities of Move Networks, Microsoft, and Apple. Move Networks has a solution called Adaptive Stream (http://www.movenetworks.com/move-media-services/move-adaptive-streaming) which provides streaming by fetching time chunks of media via HTTP. The solution allows for on-the-fly rate adaptation of the quality of the stream. Both on demand and live streaming are supported.

Microsoft has introduced Smooth Streaming (http://www.microsoft.com/downloads/details.aspx?displaylang=en&FamilyID=03d2258 3-3ed6-44da-8464-b1b4b5ca7520) which is similar to Move Networks but based on ISO files. An important aspect is Microsoft's collaboration with Akamai. Akamai's global CDN is used to caching the chunks which are later delivered with a lower latency and thereby improving the end user video play-out experience.

Apple has introduced HTTP live streaming to iPhone. An IETF draft (http://www.ietf.org/internet-drafts/draft-pantos-http-live-streaming-01.txt) describes the solution. It is similar to Move Networks but based on MPEG-2 transport stream.

FIG. 9 gives an overview of how HTTP chunk based streaming works between a client 91 and server 92. The content (whether live or stored) is chunked into files of certain time duration. The clients starts the interaction with the server by downloading a ‘manifest’ which is basically a list mapping time intervals to respective links. For live content, the manifest needs to be dynamically updated. Interesting to note is that the ‘manifest’ files are similar in nature to ‘torrent’ files used in P2P.

As discussed above, the mobility in the network is provided below the point of Present (PoP), which is currently located in the PDN-GW 26. Caching can in principle be located anywhere, but the traffic is tunnelled between the nodes (due to mobility). If caching is added into the reference architecture, it is preferable that the break-out of traffic from the tunnels is made at the Serving SAE-GW or the eNodeB, or that that the caches are located above the PoP, i.e. within the Operators IP-service network.

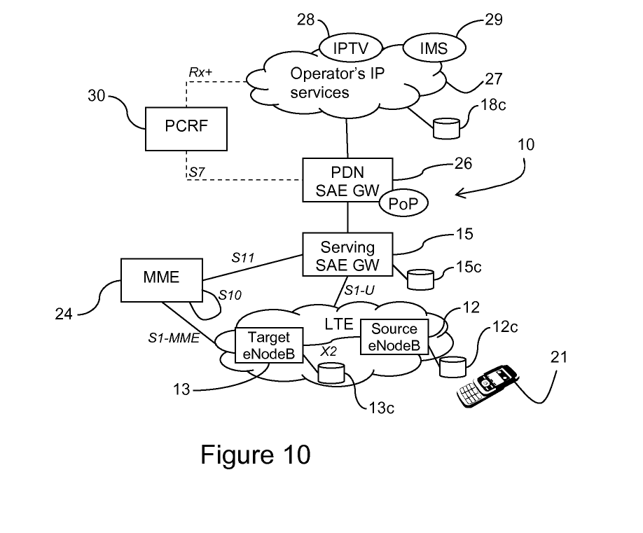

This is illustrated in FIG. 10, which shows a network architecture 10 similar to that of FIG. 2. Entities which are the same in both architectures have the same reference numerals. In the architecture of FIG. 10, cache storage media 12c, 13c, 15c may be associated with the eNodeBs 12, 13, and/or Serving SAE GW 15, respectively, so that these network elements can operate as a cache server. FIG. 10 also shows a storage medium 18c associated with the network 27 in which the operator resides.

This means that an application (i.e. RTSP-state) state in the cache server must be moved at handover between cache servers (eNodeBs 12, 13/SAE GW 15).

For content which is known to be cached below the anchor-points, the user plane RTP payload, which is the vast majority of traffic, is generated by the cache server close to the client 21 (i.e. within the SAE-GW 45 or eNodeB 12, 13). With this architecture, the application dependence becomes minimal and the application server will have improved throughput scalability because only the session control needs to be centralized. As discussed above, a robust caching solution requires a flexible solution for session state transfer between the base-stations.

The context transfer protocol (CXTP) provides a solution but is missing the functionality for supporting a variety of transport protocols in its present form. CXTP is a state-transfer protocol between the edge-routers and can be used as a container for mobility initiated transfer of states between nodes. However, the protocol was not designed to cater for transfer of caching state due to mobility. Specifically, the Feature Profile Types (FPTs) 71 that identify the way that data is organized for the particular feature contexts, allow a node to unambiguously determine the type of context and the context parameters present in the protocol messages. RFC 4067 provides an example of how context transfer is done for SCTP, but does not provide a means for the context transfer of cached data.

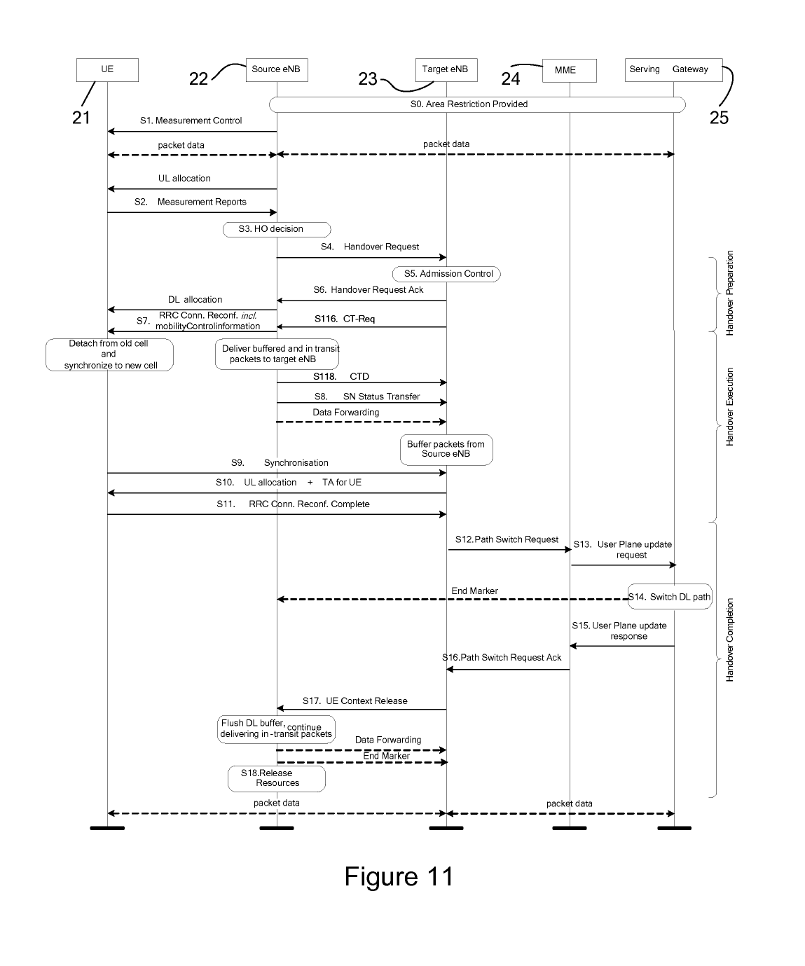

In order to transfer the states in a handover between two cache servers, CXTP messages are exchanged. Consider, for example, the source eNB 22 and target eNB 23 shown in FIGS. 2 and 3. When the handover decision is made (step S3) and the handover request is sent and acknowledged (S4 and S6), CXTP messages are exchanged at the same time. This is illustrated in FIG. 11, which is identical to FIG. 2 except that it includes additional steps S116 (CT-Req) and S118 (CTD).

When the target eNB 23 receives a handover request (S4) and carries out admission control (S5), it sends a handover request acknowledgement step (S6) as before. It also sends a separate CT-Req message S116 to request the source eNB 22 to provide session state information. The source eNB 22 replies with a CTD message S118 providing this information.

The CXTP messages are similar to those described above with reference to FIGS. 5 and 6. The state information to be transferred is included in the context data blocks (CDBs) 68, 69 as shown in FIGS. 6 and 7.

In the CDB 68, the FPT field 71 includes an indication that the context being transferred relates to cached data. This is a new profile type not included in RFC 4067. The data 78 itself is not an SCTP payload data chunk, but instead is a set of parameters defining the state of the application (e.g. HTTP).

If chunk based HTTP streaming (as described above) is being used, then the data 78 in the data section of the CDB 68 is the last streamed out chunk and the current resolution indicator (e.g. SD, HD etc.) The target eNB 23 will then continue streaming from the next consecutive chunk with the resolution that best fits the current network conditions.

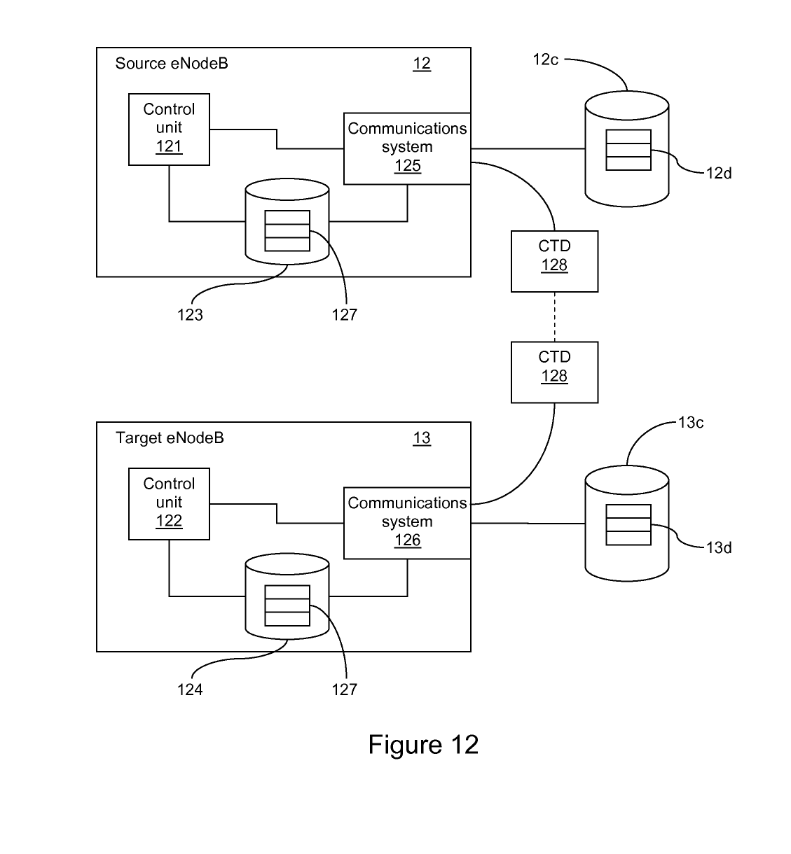

FIG. 12 is a schematic illustration of a source eNodeB 12 and target eNodeB 13, similar to those shown in FIG. 10 and configured to exchange cache state information using the CXTP protocol. Each eNodeB 12, 13 includes a control unit 121, 122 and local storage medium 123, 124, and is associated with a cache storage medium 12c, 13c (as also shown in FIG. 10) which is pre-populated with content (e.g. RTP packets, HTTP chunks) 12d, 13d.

Each eNodeB 12, 13 also includes a communications system 125, 126 for communicating with the respective cache storage medium, with other eNodeBs, and with upstream and downstream nodes in the network.

Consider the situation where a terminal (e.g. the terminal 21 shown in FIG. 10) is being sent cached data by the source eNodeB 12. The control unit 121 in the source eNodeB 12 instructs the communications system 125 to retrieve the cached data 12d from the associated cache storage medium 12c and forward it towards the terminal 21. Session state parameters 127 are stored in the local storage medium 123. These session state parameters define the state of the session, and may include, for example, RTSP sequence numbers or chunk identifiers for HTTP based streaming. It will be appreciated that this approach does not just apply to streaming data; a large file may be transferred in a TCP session in smaller chunks, and the session state parameters 127 will define which chunks have and have not been sent. It will further be appreciated that the cache storage medium 12c may be a separate entity (as shown in FIG. 12) or may be part of the eNodeB 12, in which case it may be possible for the cached data 12d to be recovered from the cache storage medium 12c without the use of the communications system 125.

If the terminal 21 moves within range of the target eNodeB 13, responsibility is handed over from the source eNodeB 12 to the target eNodeB 13. As part of the handover procedure (and in addition to the handover messages described in FIG. 3), the control unit 121 extracts the session state parameters 127 from the local storage medium 123, encapsulates them in a CXTP CTD message 128, and instructs the communications system 125 to send the CTD message 128 to the communications system of the target eNodeB 13. The session state parameters are included in the context data blocks 68, 69 shown in FIGS. 6 and 7.

The communications system 126 of target eNodeB 13 receives the CTD message 128. The control unit 122 extracts the session state parameters, and stores them in the local storage medium 124. This provides the necessary information for the communications system 126 of the target eNodeB 13 to extract the correct data 13d from its associated cache storage medium 13d to send cached data, starting from the correct point, to the terminal 21 once handover is complete.

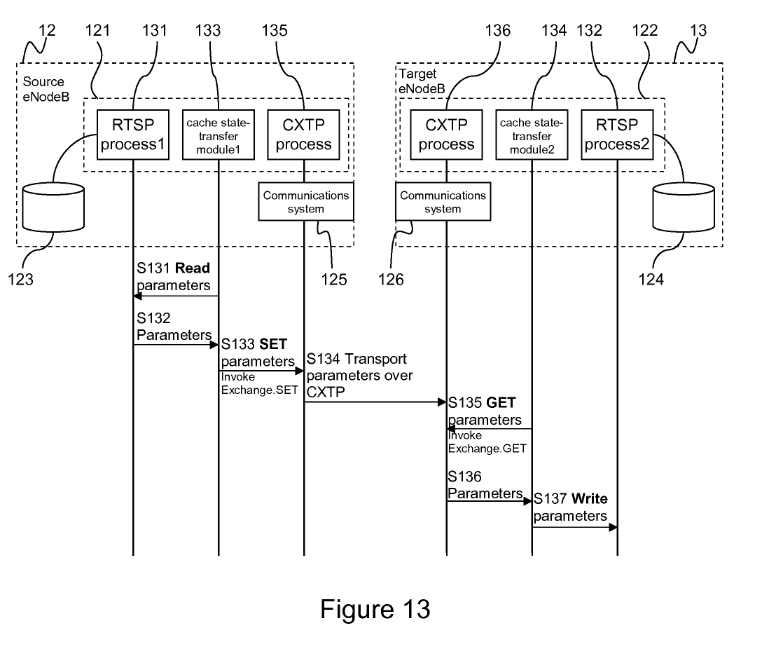

FIG. 13 is an sequence diagram showing the action of logic blocks within the control units 121, 122 of the eNodeBs 12, 13 in order to send the CTD message 128 from the source eNodeB 12 to the target eNodeB 13. Each control unit 121, 122 operates a RTSP process 131, 132 (or HTTP process, etc.), cache state-transfer module 133, 134 and CXTP process 135.

The control unit should support a GET/SET operation enabling the cache state-transfer module to populate and query the current state. A new class which exchanges parameters should be present in the CXTP process. An example of the class implementation is as follows:

class CXTP_Exchange

{

| | |
|---|---|
| List state_params; | // list of parameters |
| state_params GET( ); | // Get function |
| SET(state_params); | // Set function |

}

state_params GET( )

{

return parameters from CDB

}

SET(state_params)

{

populate CXTP CDB with parameters

}

Two alternatives are possible for the RTSP process application. In one alternative, the RTSP software must be modified to support new read/write functions:

class RSTP_Exchange

{

| | |
|---|---|
| List state_params; | // list of parameters |
| state_params Read( ); | // Read function |
| Write(state_params); | // Write function |

}

state_params Read( )

{

return specified parameters from RTSP process state

}

Write(state_params)

{

populate RTSP process state with parameters
}

In the other alternative, the memory of the operating system running the RTSP server is scanned and the current state of the RTSP process is copied. This should occur when the RTSP process is in a steady state at well defined time intervals:

class RSTP_Exchange

{

| | |
|---|---|
| List state_params; | // list of parameters |
| state_params ScanMem( ); | // Read function |
| PopulateMem(state_params); | // Write function |

}

state_params ScanMem( )

{

suspend process at time T
scan memory used by RTSP process state and extract values
insert values into ‘parameters’ list
return ‘parameters’

}

PopulateMem(state_params)

{

interrupt RTTP process
populate RTSP process state with values from ‘parameters’
return RTSP process from interrupt
}

So in FIG. 13 the steps are as follows:

S131 The cache-state transfer module 133 in the control unit 121 of the source eNodeB 12 instructs the RTSP process state 131 to return the session state parameters (stored in the local storage medium 123).
S132 The parameters are sent to the cache-state transfer module.
S133 The cache state-transfer module 133 provides the parameters to the CXTP process 135
S134 The CXTP process 135 of the source eNodeB 12 generates a CDB containing the parameters. This is sent to the CXTP process 136 of the target eNodeB 13 via the communications systems 125, 126 of the eNodeBs.
S135 The cache state-transfer module 134 in the control unit 122 of the target eNodeB 13 instructs the CXTP process 136 to send the session state parameters.
S136 The parameters are sent to the cache state-transfer module.
S137 The parameters are written to the RTSP process 132 of the target eNodeB. They can then be saved in the local storage medium and used to ensure that the correct cached data is sent to the terminal 21 from the target eNodeB 13. Once handover is complete the RTSP process 132 can therefore begin streaming (or sending files) from the correct place.

It will be appreciated that the above system is described with reference to a RTSP process, but the same approach will work for delivery of other data, such as streaming HTTP or large files by TCP, as well.

It will be appreciated that the communications systems 125, 126 and control units 121, 122 are shown as separate entities, but may in fact be operated by the same or different processors. Furthermore, they may be operated by hardware or software. If they are operated by software, either or both may include a processor and a memory including a computer program product which instructs the unit to perform the necessary operations.

The approach described above enables the reuse of an existing state transfer protocol (CXTP) to transport cache state information between eNodeBs for LTE. The use of standardized IETF-protocols facilitates the creation of standardized and open interfaces.

The approach also enables a set of application parameters to be retrieved from the memory and encapsulated in CXTP for a streaming protocol (e.g. chunk based HTTP).

The idea allows for a flat caching architecture which is more scalable compared to a centralized caching architecture. The approach also does not propose to manipulate standard transport mechanisms, but allows a gracious state transfer between streaming servers located in each cache and all this can be deployed using IETF methods.

The above discussion touches on one situation in which caching may be useful, but it will be appreciated that there are many other cases where the same principles may be applied. For example, similar caching processes are applicable for VoD using RTP over UDP and HTTP over TCP. The data need not be streaming data: the process can also be used when a long TCP session is in operation. Furthermore, the processes can be used for 2G and 3G networks in addition to LTE. It will be appreciated that, in such situations, units equivalent to the LTE units described above will be used. For example, the base stations will not be eNodeBs as described above, but will be appropriated for the relevant network architecture.

1. A source network element configured to act as a caching server for sending cached data in a session to a mobile terminal in a packet data network, the source network element comprising:
a control unit for controlling the delivery of cached data packets, stored in a cache storage unit associated with the source network element, to the mobile terminal;
a local storage medium associated with the control unit for storing session state parameters defining a state of the session; and
a communications system, configured to send the cached data packets towards the mobile terminal;
wherein the control unit is configured to implement a handover procedure to a target network element in the network so as to enable the target network element to send cached data packets, already stored in another cache storage unit associated with the target network element, towards the mobile terminal in the same session, the handover procedure comprising:
retrieving the session state parameters from the local storage medium;
inserting the session state parameters into a context data message together with an indication that the parameters relate to cached data;
and using the communications system to send the context data message to the target network element.

2. The source network element of claim 1, wherein the communications system is further configured to identify that the mobile terminal has moved within range of the target network element and responsively initiate the handover procedure by sending a handover request to the target network element.

3. The source network element of claim 1, wherein the context data message is a CXTP data message.

4. The source network element of claim 3, wherein the control unit is configured to operate a data delivery process, cache state-transfer process, and CXTP process, and wherein the cache state-transfer process is configured to recover the session state parameters from the data delivery process and deliver them to the CXTP process, and the CXTP process is configured to insert the parameters into the context data message and send them to the target network element.

5. A target network element configured to act as a caching server for sending cached data to a mobile terminal in a packet data network, the target network element comprising:
a control unit configured for controlling the delivery of cached data packets, stored in a cache storage unit associated with the network element, to the mobile terminal;
a local storage medium associated with the control unit and configured for storing session state parameters defining a state of the session; and
a communications system, configured to send the cached data packets towards the mobile terminal;
wherein the control unit is further configured to implement a handover procedure from a source network element in the network so as to enable the target network element to continue to send the cached data packets towards the mobile terminal in a session previously handled by the source network element, the handover procedure comprising:
receiving a context data message from the source network element at the communications system, the context data message containing session state parameters defining the state of the session together with an indication that the parameters relate to cached data;
inserting the session state parameters into the local storage medium;
identifying the state of the session from the session state parameters;
and using the identified state to identify a starting point in the cached data packets already stored in the cache storage unit to be sent towards the mobile terminal.

6. The target network element of claim 5, wherein the communications system is further configured to receive a handover request from the source network element to initiate the handover procedure.

7. The target network element of claim 5, wherein the context data message is a CXTP data message.

8. The target network element of claim 7, wherein the control unit is configured to operate a data delivery process, cache state-transfer process, and CXTP process, and wherein the cache state-transfer process is configured to recover the session state parameters from the CXTP process and deliver the parameters to the data delivery process, and the data delivery process is configured to deliver the parameters to the local storage medium and to control delivery of cached data packets to the mobile terminal.

9. The network element of claim 7, wherein the cache storage unit is included in the network element.

10. The network element of claim 7, wherein the network element is a base station.

11. The network element of claim 7, wherein the cached data sent to the mobile terminal is streaming data.

12. The network element of claim 11, wherein the streaming data is HTTP streaming data.

13. The network element of claim 11, wherein the packets are RTP packets.

14. The network element of claim 11, wherein the packet data network is a 3GPP or SAE LTE network, and the network element is an eNodeB.

15. A method of handing over a connection to a terminal from a source base station to a target base station in a packet data network when the source base station is acting as a caching server and sending content data towards the terminal in a session, the method comprising:
sending a handover request from the source base station to the target base station;
sending a context data message from the source base station to the target base station, the context data message including session state parameters identifying the state of the session together with an indication that the parameters relate to cached data;
at the target base station, retrieving the session state parameters from the context data message and using them to identify the state of the session;
retrieving the content data packets from a cache storage unit associated with the target base station; and
sending the content data packets from the target base station towards the terminal so as to continue the session.

16. A computer program product comprising code adapted to be executed on a source network element in a packet data network, the code configured, when executed by the source network element, to:
retrieve content data packets from a cache storage medium associated with the network element;
send the content data packets in a session towards a terminal in the network;
send a handover request to a target network element in the network;
insert current session state parameters, together with an indication that the parameters relate to cached data, into a context data message and send the context data message towards the target network element so as to enable the target network element to send cached data packets, already stored in another cache storage medium associated with the target network element, towards the terminal in the same session; and
stop sending the content data packets towards the terminal.

17. A computer program product comprising code adapted to be executed on a target network element in a packet data network, the code configured, when executed by the target network element, to:
receive a handover request from a source network element in the network;
receive a context data message from the source network element, the context data message including session state parameters for a data delivery session to a terminal in the network together with an indication that the parameters relate to cached data;
store the session state parameters in a local storage medium;
use the session state parameters to identify a state of the data delivery session;
retrieve content data packets intended for the data delivery session from a cache storage medium associated with the network element, the content data packets being chosen so that the data delivery session to the terminal can continue uninterrupted; and
send the content data packets towards the terminal so as to continue the data delivery session.

18. The computer program product of claim 16, carried on a nontransitory carrier medium.
